(19) United States
(12) Patent Application Publication
(10) Pub. No.: US 2024/0313560 A1
(43) Pub. Date: Sep. 19, 2024

(54) RECONFIGURABLE OFFICE SPACE ORGANIZERS AND WORKSPACE ASSEMBLY WITH PORTABLE POWER SOURCE

(71) Applicant: August Berres Corporation, Lewes, DE (US)

(72) Inventors: Robert Kroon, South San Francisco, CA (US); Robert Russell, Kentwood, MI (US); Sterling Pau, Vancouver, WA (US)

(21) Appl. No.: 18/604,565

(22) Filed: Mar. 14, 2024

Related U.S. Application Data
(60) Provisional application No. 63/490,034, filed on Mar. 14, 2023.

(51) Int. Cl. H02J 7/00; H01M 10/46; H01M 50/209; H01M 50/247; H01M 50/262

(52) U.S. Cl. CPC H02J 7/0045; H01M 10/46; H01M 50/209; H01M 50/247; H01M 50/262; H01M 2220/30

(57) ABSTRACT

A rechargeable power system includes a bracket configured to mount at a panel of a workstation. The bracket includes an upper cover, a receiving plate and a lower cover. The upper cover is disposed at an upper surface of the panel and at least partially circumscribes an aperture formed through the panel. An aperture is formed through the upper cover and is at least partially aligned with the aperture of the panel. The receiving plate is disposed at a lower surface of the panel and extends at least partially along the aperture of the panel. The lower cover is disposed below and extends at least partially along the receiving plate. A battery pack is received through the apertures of the upper cover and the panel and at a receiving portion of the receiving plate. The battery pack is operable to electrically power an electronic device at the workstation.

### CROSS REFERENCE TO RELATED APPLICATION

The present application claims the filing benefits of U.S. provisional application Ser. No. 63/490,034, filed Mar. 14, 2023, which is hereby incorporated herein by reference in its entirety.

### FIELD OF THE INVENTION

The present invention relates generally to furniture and, more particularly, to office space organizers and workspace assemblies.

### BACKGROUND OF THE INVENTION

Modular furniture is generally known in the art. It is also known to have battery power source modules, such as described in U.S. Pat. Pub. No. US-2022-0069598, which is hereby incorporated herein by reference in its entirety.

### SUMMARY OF THE INVENTION

An example of a rechargeable and portable power system that is configured to mount at a work surface of a workstation includes a bracket that is configured to mount at a panel or work surface of a workstation, such as a desk top, conference table, and the like. The bracket includes an upper cover, a receiving plate and a lower cover. The upper cover of the bracket, with the bracket mounted at the panel, is disposed at an upper surface of the panel, and at least partially circumscribes an aperture formed through the panel. An aperture is formed through the upper cover of the bracket and is at least partially aligned with the aperture formed through the panel. The receiving plate is disposed at a lower surface of the panel that is opposite the upper surface and extends at least partially along the aperture formed through the panel. The lower cover is disposed below and extends at least partially along the receiving plate. With the bracket mounted at the panel, a battery pack is received through the aperture of the upper cover, through the aperture of the panel, and at a receiving portion (e.g., a socket or docking station) of the receiving plate to secure the battery pack at the bracket. The battery pack, when received at the receiving portion of the receiving plate, is operable to electrically power one or more electronic devices at the workstation.

Another example of a rechargeable power system includes a mounting assembly configured to mount at a workstation equipped with the rechargeable power system. The mounting assembly includes a tray or tub portion that is received at an aperture formed through a panel of the workstation and a cover portion that is removably received at the tray portion. The cover portion includes a receiving portion or socket that receives a battery pack. The battery pack electrically powers an electronic device at the workstation or an electronic accessory of the workstation. The cover portion is removable from the tray portion to remove the cover portion and the battery pack from the tray portion and the panel of the workstation, such as to transport the cover portion and the battery pack to a charging station remote from the workstation for electrically charging the battery pack.

These and other objects, advantages, purposes and features of the present invention will become apparent upon review of the following specification in conjunction with the drawings.

### BRIEF DESCRIPTION OF THE DRAWINGS

FIG. 1 shows views of a rechargeable and portable power assembly integrated with a workstation;

FIG. 2 is an exploded view of the portable power assembly;

FIG. 3 is an exploded view of another portable power assembly with a removable upper cover accommodating battery packs; and

FIG. 4 is an exploded view of a charging station configured to receive and charge the battery packs of the portable power assembly of FIG. 3.

### DESCRIPTION OF THE PREFERRED EMBODIMENTS

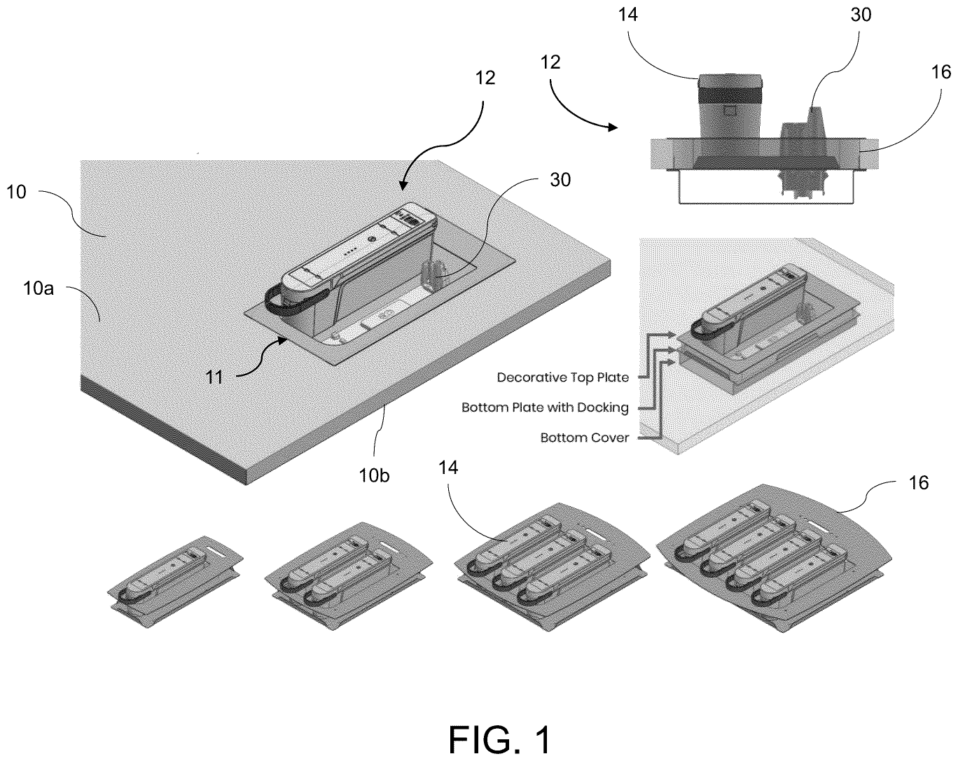

Referring now to the drawings and the illustrated embodiments depicted therein, a rechargeable and portable power system or assembly 12 is configured to mount at a panel or work surface 10 of a workstation (FIG. 1). The power system 12 includes a bracket or mounting assembly 16 that mounts to the work surface 10 and that removably receives one or more rechargeable battery packs or energy storage devices 14. The one or more battery packs 14 are operable to provide electric power to one or more electronic devices at the workstation, such as via one or more outlets or ports (e.g., one or more electrical outlets and/or one or more USB ports) of the battery pack 14, and are removable from the bracket 16 to be recharged and/or replaced with charged battery packs 14. Furthermore, the bracket 16 is configured for mounting at existing workstations that may be retrofitted with the power system 12. Thus, and as discussed further below, the power system 12, when mounted at the work surface 10, provides a cordless energy solution for the workstation that improves the mobility of the workstation and that improves the configurability of workstations in use within an office or work space.

When installed at the work surface 10, the power system 12 is disposed at an aperture or hole 11 formed through the work surface 10. The aperture 11 may be pre-formed through the work surface 10, or the user may cut the aperture 11 into the work surface 10 to retrofit an existing work surface 10 to be able to accommodate the power system 12. For example, a template may be provided to the user to ensure that the aperture 11 is properly sized and shaped to receive the bracket 16 of the power system. Thus, the power assembly 12 may be installed at any suitable planar structure of the workstation, such as a desk top, a conference table, a vertical wall panel, and the like. The workstation may include characteristics of the workstations described in U.S. Pat. Pub. No. US-2022-0251832, which is hereby incorporated herein by reference in its entirety.

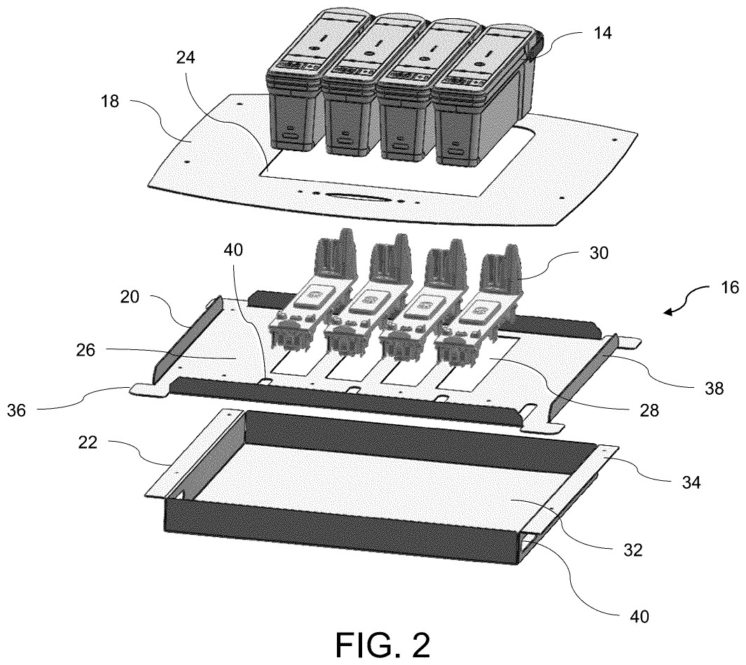

With the aperture 11 formed through the work surface 10, the bracket 16 is configured to mount to the work surface 10 at and around and/or through the aperture 11. As shown in FIG. 2, the bracket 16 includes a first or upper layer or cover 18 that is disposed at an upper surface 10a of the panel 10 and that at least partially circumscribes the aperture 11 at the upper surface 10a. A second or central layer or receiving plate 20 is disposed at a lower surface 10b of the panel 10 and at least partially circumscribes the aperture 11 at the lower surface 10b. A third or lower layer or cover 22 is disposed beneath the second layer 20 and extends along and beneath a lower surface of the second layer 20. One or more fasteners extend through the upper cover 18, the work surface 10, the central layer 20, and the lower cover 22 and, when tightened, clamp the bracket 16 to the work surface 10. Optionally, a portion of the upper cover 18 and/or a portion of the central layer 20 (such as a flange extending from one or both of the upper cover and central layer) extend through and along at least a portion of the aperture 11, such as to locate the bracket at the aperture and preclude compression of the work surface 10 when the bracket is clamped to the work surface.

The upper cover 18 may provide a decorative aspect to the bracket 16 and may be substantially flush with the upper surface 10a of the work surface 10 when installed at the workstation. An aperture 24 is formed through the upper cover 18 so that the one or more batteries 14 can be received through the aperture 24 and supported by the central layer 20 of the bracket 16. For example, a receiving portion 26 of the central layer 20 extends at least partially over the aperture 11 at the lower surface 10b of the work surface 10 and includes one or more sockets or apertures 28 configured to removably receive respective batteries 14.

In the illustrated example, the respective sockets 28 each receive a docking station 30 that couples to a battery 14 received at the docking station 30. The docking station 30 may electrically couple the battery 14 to an electronic component of the workstation (e.g., a standing desk or mobility function of the workstation) or one or more outlets disposed at the workstation (such as at a position along the work surface remote from the power system) and electrically coupled to the docking station 30 to deliver power from the battery 14 to the outlet or port.

The lower cover 22 includes a lower panel or tray portion 32 that extends over and along the central layer 20 to conceal and protect any electronic components (e.g., wiring) disposed at the bracket 16. Optionally, the lower cover 22 may be integrally formed with the central layer 20 such that the bracket 16 is mounted to the work surface 10 by fastening the upper cover 18 to the integrally formed lower and central layers through the work surface 10.

The bracket 16 may be configured to receive any suitable number of battery packs 14 and/or docking stations 30. For example, the bracket 16 may be configured to accommodate one battery, two batteries, three batteries, four batteries, or more (e.g., FIG. 1). When a plurality of batteries are accommodated by the power system 12, the batteries may be collectively electrically coupled to a power outlet (e.g., so that the multiple batteries provide longer continuous power supply to the power outlet) or the batteries may be electrically coupled to separate individual power outlets, such as at the respective battery (e.g., so that the batteries may electrically power different respective electronic devices). As shown, the bracket 16, and thus the aperture 11 of the work surface 10, may be sized based on the number of batteries the bracket is configured to receive.

Thus, when installed at the workstation, the power system 12 may be configured to provide cordless electrical power via the batteries 14 to an electronic function of the workstation (e.g., a standing desk function, a light source, a mobility function, and the like). For example, the one or more docking stations 30 may be electrically coupled to the electronic function of the workstation via wiring disposed at the bracket 16 so that, when the battery 14 is received at the docking station 30, the battery 14 delivers electrical power via the wiring at the bracket 16. Furthermore, the power system 12 may be configured to provide cordless electrical power via the batteries 14 to one or more electronic devices (e.g., a light or lamp, a laptop or desktop computer, a monitor, and the like) at the workstation and electrically connected to the batteries 14 via one or more outlets that may be integrated with the battery 14, the bracket 16, and/or the workstation. The bracket may accommodate one or more power regulators electrically coupled to the batteries to ensure that the batteries provide even distribution of power. The batteries 14 may be removable from the bracket 16, such as to be recharged at a docking station remote from the workstation and/or to be replaced with recharged batteries.

In the illustrated example of FIG. 2, the lower cover 22 includes a peripheral flange 34 that extends from opposing ends of the tray portion 32. With the power system 12 installed at the work surface 10, the peripheral flange 34 extends along the lower surface 10b of the work surface 10 at or near opposing side edges of the aperture 11. The central layer 20 of the bracket 16 extends along the aperture 11 and along the tray portion 32 between the lower cover 22 and the bottom surface 10b of the work surface 10, with respective tabs 36 at corner regions of the central layer 20 extending at least partially along the peripheral flange 34. Thus, mechanical fasteners may extend through the peripheral flange 34, the tabs 36, and the upper cover 18 of the bracket 16 to attach the bracket 16 at the work surface 10. The central layer 20 may include upward extending flanges 38 that extend along the outer edges of the aperture 11 to locate the bracket 16 at the work surface 10. Further, the central layer 20 and/or the lower cover 22 may include one or more slots or apertures 40 formed therethrough to accommodate electrical wiring extending between the tray portion 32, an area between the central layer 20 and the work surface 10 and/or upper cover 18, and exterior the bracket 16 (e.g., below the work surface).

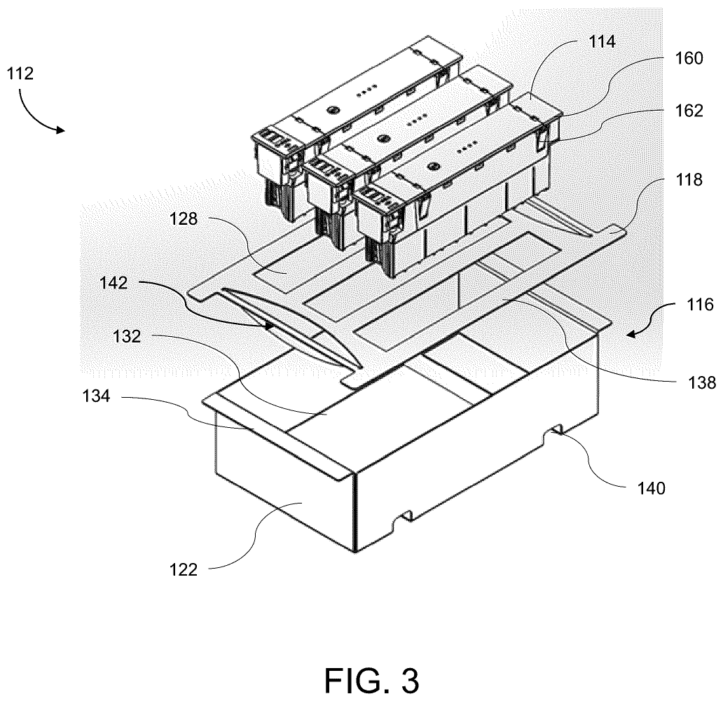

Optionally, the lower cover may drop into the aperture, with a flange or lip of the lower cover extending at least partially along the upper surface of the work surface to retain the power system at the workstation. For example, and as shown in FIG. 3, a power system 112 includes a bracket 116 having a lower cover or tub 122 including a tray portion 132 and a peripheral lip or flange 134 extending at least from opposing side edges of the tray portion 132. When the bracket 116 is disposed at the work surface, the peripheral lip 134 rests at the upper surface of the work surface and the tray portion 132 extends into the aperture and below the work surface.

An upper cover 118 mates to the lower cover 122 at an upper edge of the lower cover 122, such as snap attaches or press fits to the lower cover 122, and extends along the tray portion 132. The upper cover 118 includes one or more sockets 128 that receive respective battery packs 114. One or more slots or apertures 140 may be formed through the upper cover 118 and/or the lower cover 122 to accommodate electrical wiring that extends from within the tray portion 132 (i.e., between the lower cover 122 and the upper cover 118) and exterior the bracket 116 (e.g., above or below the work surface). Further, the upper cover 118 includes grasping portions or handles 142 along opposite ends of the upper cover 118 so that a user may lift the upper cover 118 (and the battery packs 114) out of the tray portion 132, such as to transport the upper cover 118 and battery packs 114 to a charging station. For example, the battery packs 114 may include upper flanges or peripheral edges 160 that rest on the upper cover 118 to support the battery pack 114 when received through the socket 128 and flexible tabs 162 received through the socket 128 to preclude the battery pack 114 from being inadvertently pulled out of the socket 128. When the upper cover 118 is disposed at the lower cover 122, a portion of the handle 142 extends into the tray portion 132 to locate the upper cover 118 at the lower cover 122.

With the bracket 116 disposed at the work surface, the peripheral flanges 134 extend along opposing edges of the aperture of the work surface (e.g., along the short edges of a rectangular aperture) and partially along the upper surface of the work surface. The upper cover 118 includes flanges 138 that extend along other opposing edges of the aperture of the work surface (e.g., along the long edges of the rectangular aperture). Thus, all edges of the aperture are covered and/or hidden from view by flanges of the bracket 116.

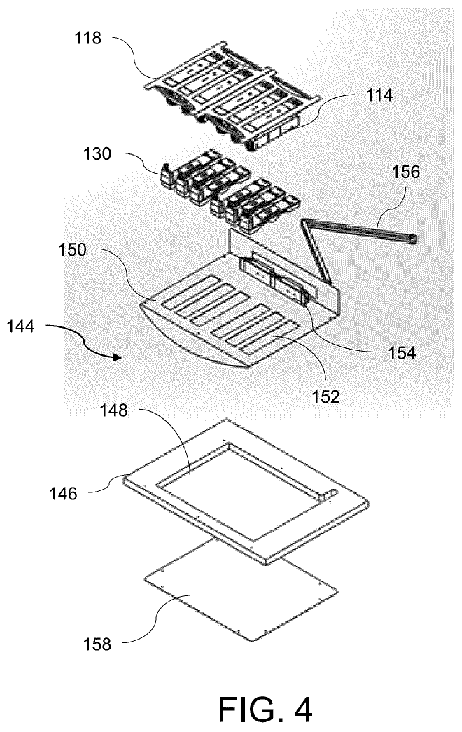

The handles 142 allow the upper cover 118 and the battery packs 114 to be lifted and removed from the lower cover 122 as one unit (with the lower cover 122 remaining at the work surface) and transported to a charging system for the battery packs 114. For example, and as shown in FIG. 4, a charging system or station 144 may be disposed at a shelf or drawer 146 of a cabinet (e.g., in the work environment accommodating the workstation). The shelf 146 includes an aperture 148 formed therethrough for accommodating the battery packs 114. A frame or cover 150, such as a metallic frame, is attached at the shelf 146 and extends over and along the aperture 148. One or more sockets or shoes 152 are formed through the frame 150 and configured to receive respective docking stations 130 that receive and transfer electrical power to respective battery packs 114. The docking stations 130 may be electrically connected to an external power source (e.g., an electrical outlet) via one or more power supplies (e.g., inverters) 154 disposed at the frame 150. The power supplies 154 may electrically connect to the external power source via electrical wiring that extends from the frame 150. For example, the electrical wiring may extend along a hinge arm 156 that electrically connects between the frame 150 and/or shelf 146 and rear structure of the cabinet so that, when the shelf or drawer 146 is moved in and out of the cabinet, the hinge arm 156 extends and retracts to extend the electrical wiring and prevent tangling or snagging of the wiring. A cover 158 may extend over the aperture 148 and attach at a lower surface of the shelf 146.

Thus, when the upper cover 118 and battery packs 114 are transported to the charging station 144, the battery packs 114 may be aligned with and docked at respective docking stations 130 accommodated within the sockets 152. The battery packs 114 are electrically charged via electrical power from the external power source via the power supplies 154. In the illustrated example, the charging station 144 is configured to accommodate two assemblies of the upper cover 118 and corresponding battery packs 114, and thus the charging station 144 receives and charges six battery packs 114. The charging station 144 may be configured to receive and charge any suitable number of battery packs 114.

In other words, a user may cut the right size hole or aperture into a work surface, such as a conference table, and then install the metal tub component. The metal tub has two flanges that hide the cut hole on the short edges. The next layer of metal is shaped with flanges that cover the long edges of the hole. This part nests into the tub using the ends of the handles (e.g., downward flanges) for proper alignment. The battery packs may be positioned and spaced in a way that the top cover with the batteries can be lifted away from the lower cover and the table and placed at a charging system to charge depleted battery packs. Battery packs (such as with dual USB-C connections (or with a USB-C and a USB-A connection) provide six or more powered ports, such as for laptops. For example, two assemblies can be disposed on opposite ends of a large conference table to provide power for 12 users. Each assembly may have 600 Watt hours or more of power. Since laptops typically consume 5 to 15 watts, there may be more than enough power for a work day.

In some examples, the charging system can be built into a cabinet, where a portion of the cabinet can be used to place the batteries to be charged. The battery packs accommodated at the upper cover are fit onto docking shoes at the shelf of the cabinet. DC power is provided by the power supplies that are located in the vertical flange at the back of the shelf. The shelf includes the hinged arm to route the input power cord to the power supplies and keep the power cord from getting tangled as the drawer is moved in and out of the cabinet. There may be a hinge point on the shelf, in the middle of the arm and at the rear. A bracket at the rear is attached to the cabinet structure. A cover attaches to the bottom of the shelf to hide and protect the wiring that spans between the charging shoes and the power supplies. For example, one shelf may pair with a 12-person conference table.

The power system may be configured to supply power to laptop computers, desktop computers, computer monitors, sit-stand mechanisms, wireless phone chargers, wireless (e.g., 5G) hotspots, UVC light disinfection lamps, printers, and light sources.

Thus, the workstation equipped with or retrofitted with the power system provides improved mobility for the workstation as the workstation does not need to be positioned near power outlets. Furthermore, an office space or work space equipped with workstations having the power system is easily reconfigurable without consideration of existing power outlet locations, or construction to change or add power outlet locations.

In other words, the power system provides the value of not having cords or wires on the floor of the office space and not having to secure permits, hire electrical contractors, and suffer through inspections when changing a layout of the office space. For example, conference rooms are often high profile spaces and users do not want to see cords and wires on the floor. Typically, a user may choose to core the floor or make a trench that covers wires. However, this may be a costly process and may not be possible in all work environments, such as in high-rise buildings where there may be steel reinforcements in the concrete that cannot be cut. The power system may be a way to power laptops and other electronics at a conference room table without coring the floor.

Furthermore, because the power system 12 may be installed at existing workstations, an office with existing inventory of office furniture may benefit from the power system. For example, many state and local agencies or unions have standardized on a panel system layout (e.g., 8 foot by 8 foot is typical). The power system provides a retrofit kit that can be adapted to any office system to convert it to battery power rather than AC power. There may be four or more versions, from a single battery dock to four docks, or more.

There may be three “layers” to the product. To be installed, a furniture installer may first cut the appropriate size hole in a work surface using a common plunge router and a provided template. The top layer may be decorative and its underside has male fasteners that mate with a female connector that goes through the other two layers. When screwed or fastened together, the three layers clamp to the work surface. The center layer has one to four or more docking positions, depending on the version, for the one to four or more battery packs.

All the wiring between each docking shoe is attached to the center layer. Also, there may be voltage regulators attached to this layer, such as to provide constant power for computer monitors. The voltage regulators may each have a cable (e.g., one meter long) with a barrel connector that pairs with, for example, computer monitors commercially available from Samsung® or LG®, both of Seoul, South Korea. A power inverter option may be included that will provide AC power for high power consumption devices. Another item is a battery-powered geo-location feature.

Thus, the power system may provide a multiplicity of battery-powered components that interact with a multiplicity of battery-powered devices. The decorative top layer may comprise a multiplicity of designs. The bottom layer may be a simple cover that prevents accidental damage or unwiring of the middle layer. The battery pack may rest in the dock without the use of tools.

Therefore, when integrated with office furniture, the power system incorporates the benefits of cordless power into existing furniture or custom workstations. This may extend the life cycle of previous office furniture investments.

A single docking station may power a workstation for a typical user for about six hours or more, including powering a laptop computer and one or more monitors. A two-position docking station may enable longer continuous use or power more equipment in the workstation. For example, the docking station may power larger monitors or co-locate two people working at the same working station. A three-position docking station may enable longer continuous use or allow for more equipment in the workstation. For example, four or more monitors may be daisy-chained to each other and powered by the power system. A four-position docking station may enable even longer continuous use or even more equipment in the workstation. Furthermore, the docking station may serve as a power solution for cordless conference tables and may include additional outlets (e.g., a 120 volt outlet or a USB outlet).

Thus, existing furniture can be retrofitted to cordless power, making future changes (e.g., to office layouts) less costly and less disruptive. Cordless power does not require the planning complexity, cost, and delays in securing permits, electrical contractors, and inspectors for every office reconfiguration. Cordless power also adds value to used furniture and can be used with custom furniture designs like conference tables or reception areas.

Various embodiments and optional designs and accessories are disclosed and shown herein. The scope of this disclosure is not limited to the various embodiments and optional designs and accessories. The dimensions and tolerances shown and discussed below are intended to be exemplary of one or more particular designs of the assembly and are in no way intended to limit the scope of the particular embodiments disclosed herein.

Changes and modifications in the specifically described embodiments can be carried out without departing from the principles of the invention, which is intended to be limited only by the scope of the appended claims, as interpreted according to the principles of patent law including the doctrine of equivalents.

1. A rechargeable power system, the rechargeable power system comprising:
a bracket configured to dispose the rechargeable power system at a panel of a workstation equipped with the rechargeable power system, wherein the bracket comprises an upper cover, a receiving plate and a lower cover;
wherein the upper cover of the bracket, with the rechargeable power system disposed at the panel of the workstation, is disposed at an upper surface of the panel and at least partially circumscribes an aperture formed through the panel;
wherein an aperture is formed through the upper cover of the bracket, and wherein, with the rechargeable power system disposed at the panel of the workstation, the aperture of the upper cover of the bracket is at least partially aligned with the aperture formed through the panel;
wherein, with the rechargeable power system disposed at the panel of the workstation, the receiving plate is disposed at a lower surface of the panel that is opposite the upper surface and extends at least partially along the aperture formed through the panel;
wherein, with the rechargeable power system disposed at the panel of the workstation, the lower cover is disposed below and extends at least partially along the receiving plate;
wherein, with the rechargeable power system disposed at the panel of the workstation, a battery pack is received through the aperture of the upper cover of the bracket and through the aperture of the panel and at a receiving portion of the receiving plate to detachably attach the battery pack at the bracket; and
wherein, with the rechargeable power system disposed at the panel of the workstation, and with the battery pack received at the receiving portion of the receiving plate, the battery pack is operable to electrically power an electronic device at the workstation.

2. The rechargeable power system of claim 1, wherein the receiving portion of the receiving plate comprises a socket formed at least partially through the receiving plate.

3. The rechargeable power system of claim 1, wherein the receiving portion of the receiving plate comprises a docking station disposed at the receiving plate and configured to receive the battery pack.

4. The rechargeable power system of claim 3, wherein the docking station electrically connects the battery pack to the electronic device at the workstation.

5. The rechargeable power system of claim 4, wherein the docking station electrically connects to the electronic device at the workstation via electrical wiring disposed at the receiving plate of the bracket.

6. The rechargeable power system of claim 1, wherein the battery pack comprises an electrical outlet configured to electrically connect to the electronic device at the workstation.

7. The rechargeable power system of claim 1, wherein, with the rechargeable power system disposed at the panel of the workstation, a fastener extends through the upper cover, the receiving plate and the lower cover, and the fastener is tightened to secure the bracket at the panel.

8. The rechargeable power system of claim 1, wherein the battery pack comprises a plurality of battery packs, and wherein each battery pack of the plurality of battery packs is received through the aperture of the upper cover of the bracket and through the aperture of the panel and at a respective receiving portion of a plurality of receiving portions of the receiving plate to detachably attach the respective battery pack at the bracket.

9. A rechargeable power system, the rechargeable power system comprising:
a mounting assembly configured to dispose the rechargeable power system at a workstation equipped with the rechargeable power system, wherein the mounting assembly comprises (i) a tray portion that, with the rechargeable power system disposed at the workstation, is received at an aperture formed through a panel of the workstation, and (ii) a cover portion removably received at the tray portion;
wherein the cover portion comprises a socket configured to receive a battery pack;
wherein, with the rechargeable power system disposed at the panel of the workstation, and with the battery pack received at the socket of the cover portion, the battery pack is operable to electrically power an electronic device at the workstation; and
wherein, with the rechargeable system disposed at the panel of the workstation, and with the battery pack received at the socket of the cover portion, the cover portion is removable from the tray portion to remove the cover portion and the battery pack from the tray portion and the panel of the workstation.

10. The rechargeable power system of claim 9, wherein, with the cover portion removably received at the tray portion, the cover portion extends over and along an interior portion of the mounting assembly between the cover portion and the tray portion, and wherein, with the battery pack received at the socket of the cover portion, the battery pack is at least partially received within the interior portion of the mounting assembly.

11. The rechargeable power system of claim 9, wherein the tray portion comprises a peripheral flange extending from a side wall of the tray portion, and wherein, with the rechargeable power system disposed at the workstation, the peripheral flange rests at an upper surface of the panel of the workstation and the side wall extends through the aperture of the panel of the workstation.

12. The rechargeable power system of claim 11, wherein the tray portion comprises a bottom surface extending between respective side walls of the tray portion.

13. The rechargeable power system of claim 9, wherein the cover portion comprises a flange, and wherein, with the rechargeable power system disposed at the workstation, and with the cover portion removably received at the tray portion, the flange extends at least partially through the aperture of the panel of the workstation and along a side wall of the tray portion to locate the cover portion at the tray portion.

14. The rechargeable power system of claim 9, wherein the cover portion comprises a grasping portion that is graspable by a user to remove the cover portion from the tray portion.

15. The rechargeable power system of claim 9, wherein, with the battery pack received at the socket of the cover portion, a peripheral flange of the battery pack rests at an upper surface of the cover portion at or near the socket.

16. The rechargeable power system of claim 9, wherein, with the cover portion and the battery pack removed from the tray portion and the panel of the workstation, a charging station is configured to receive the cover portion and the battery pack to electrically charge the battery pack, and wherein the charging station is remote from the workstation.

17. The rechargeable power system of claim 16, wherein the charging station comprises a docking station configured to electrically connect to the battery pack when the cover portion and the battery pack are received at the charging station, and wherein, with the cover portion received at the charging station, the battery pack is aligned with the docking station for electrically connecting to the docking station.

18. A rechargeable power system, the rechargeable power system comprising:
a mounting assembly configured to dispose the rechargeable power system at a workstation equipped with the rechargeable power system, wherein the mounting assembly comprises (i) a tray portion that, with the rechargeable power system disposed at the workstation, is received at an aperture formed through a panel of the workstation, and (ii) a cover portion removably received at the tray portion;
wherein the tray portion comprises a peripheral flange extending from a side wall of the tray portion, and wherein, with the rechargeable power system disposed at the workstation, the peripheral flange rests at an upper surface of the panel of the workstation and the side wall extends through the aperture of the panel of the workstation;
wherein the cover portion comprises a flange, and wherein, with the rechargeable power system disposed at the workstation, and with the cover portion removably received at the tray portion, the flange extends at least partially through the aperture of the panel of the workstation and along the side wall of the tray portion to locate the cover portion at the tray portion;
wherein the cover portion comprises a socket configured to receive a battery pack;
wherein, with the rechargeable power system disposed at the panel of the workstation, and with the battery pack received at the socket of the cover portion, the battery pack is operable to electrically power an electronic device at the workstation; and
wherein, with the rechargeable system disposed at the panel of the workstation, and with the battery pack received at the socket of the cover portion, the cover portion is removable from the tray portion to remove the cover portion and the battery pack from the tray portion and the panel of the workstation.

19. The rechargeable power system of claim 18, wherein the cover portion comprises a grasping portion that is graspable by a user to remove the cover portion from the tray portion.

20. The rechargeable power system of claim 18, wherein, with the cover portion and the battery pack removed from the tray portion and the panel of the workstation, a charging station is configured to receive the cover portion and the battery pack to electrically charge the battery pack, and wherein the charging station is remote from the workstation.
